(19) United States
(12) Patent Application Publication
(10) Pub. No.: US 2007/0072658 A1
(43) Pub. Date: Mar. 29, 2007

(54) Clam Type Mobile Phone

(76) Inventor: Chun-Yi Cheng, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/428,416

(22) Filed: Jul. 3, 2006

(30) Foreign Application Priority Data
Sep. 27, 2005 (TW) 94133590

(51) Int. Cl. H04M 1/00

(52) U.S. Cl. 455/575.3

(57) ABSTRACT

A clam type mobile phone includes a base, a motherboard, a hinge seat, a display device and a vibrator. The motherboard is configured in the base. The hinge seat is mounted on one side of the base. The display device is mounted on the hinge seat. The hinge seat enables the display device to rotate relative to the base. The vibrator is configured in the hinge seat and electrically connected to the motherboard for providing the clam type mobile phone with a vibration function.

### RELATED APPLICATIONS

The present application is based on, and claims priority from, Taiwan Application Serial Number 94133590, filed Sep. 27, 2005, the disclosure of which is hereby incorporated by reference herein in its entirety.

### BACKGROUND

1. Field of Invention

The present invention relates to a clam type mobile phone. More particularly, the present invention relates to a clam type mobile phone with a vibration function.

2. Description of Related Art

With economic advancements and high living standards has come great demand for mobile phones that have much more functionality than the traditional communication functions. Modern consumers demand mobile phones with amazing appearance, novel functions and small size.

Manufactures spend great effort and resources reducing the size of mobile phones. However, configuring a large amount of functional modules within a small-sized mobile phone is not an easy task. Traditionally, the hinge seat of a typical clam type mobile phone only holds a spring hinge and a flexible printed circuit. How to utilize the inner space of the hinge seat is becoming more and more important because the inner space of the clam type mobile phone is becoming more and more limited.

Furthermore, many commercial mobile phones have a vibration function, which is provided by configuring a vibrator on the motherboard of the mobile phones. However, the motherboard absorbs the vibratory energy produced by the vibrator when the vibrator vibrates. Moreover, the inner space of the base of the mobile phone that houses the motherboard is so small that a resonant effect cannot be implemented for raising the efficiency of the vibration function. Thus, the vibrator has to produce more vibratory energy to satisfy typical users who want to feel a strong vibration.

For the foregoing reasons, there is a need for a clam type mobile phone that effectively utilizes the inner space of the hinge seat and significantly raises the efficiency of the vibration function.

### SUMMARY

It is therefore an aspect of the present invention to provide a clam type mobile phone for effectively utilizing the inner space of the clam type mobile phone.

It is another aspect of the present invention to provide a clam type mobile phone with more functional modules. The functional module is configured in the clam type mobile phone while type mobile phone still has the advantage of small size.

It is still another aspect of the present invention to provide a clam type mobile phone for significantly raising the efficiency of the vibration function of the clam type mobile phone.

In accordance with the foregoing and other aspects of the present invention, a clam type mobile phone is provided. One embodiment of the clam type mobile phone includes a base, a motherboard, a hinge seat, a display device and a vibrator The motherboard is configured in the base. The hinge seat is mounted on one side of the base. The display device is mounted on the hinge seat. The hinge seat enables the display device to rotate relative to the base. The vibrator is configured in the hinge seat and is electrically connected to the motherboard for providing the clam type mobile phone with a vibration function.

The clam type mobile phone according to the embodiment of the invention may include at least one spring hinge configured in the hinge seat. The spring hinge enables the display device to rotate relative to the base partially by a spring force.

The vibrator may include a motor and an eccentric pendulum. The eccentric pendulum is mounted on the motor for providing the clam type mobile phone with the vibration function. In this embodiment of the invention, the eccentric pendulum is made of metal. However, the eccentric pendulum may also be made of polymer, plastic, rubber, wood, carbon, carbon fiber or other appropriate material.

Furthermore, the clam type mobile phone according to this embodiment of the invention may include a flexible printed circuit electrically connecting the display device and the motherboard and wound around the hinge seat. In another embodiment of the invention, the flexible printed circuit may be passed through the hinge seat or be assembled in other ways.

In conclusion, the clam type mobile phone according to the foregoing embodiments of the invention can have the advantage of small size because the vibrator is configured in the hinge seat for effectively utilizing the inner space of the hinge seat. In addition, the motherboard can have more spaces to enable more functional modules to be configured therein because the vibrator originally configured on the motherboard is configured in the hinge seat. Moreover, the efficiency of the vibration function is raised when the vibrator vibrates because the hinge seat implements a resonant effect.

It is to be understood that both the foregoing general description and the following detailed description are by examples and are intended to provide further explanation of the invention as claimed.

### BRIEF DESCRIPTION OF THE DRAWING

The accompanying drawing is included to provide a further understanding of the invention and is incorporated in and constitutes a part of this specification. The drawing illustrates embodiments of the invention and, together with the description, serves to explain the principles of the invention. In the drawing,

FIG. 1 is a perspective drawing of a clam type mobile phone according to one preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

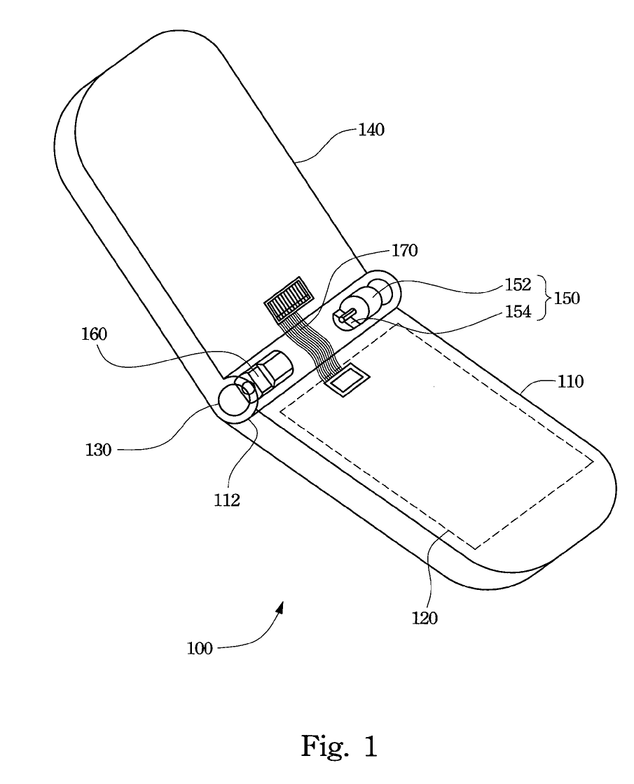

Reference is made to FIG. 1, which is a perspective drawing of a clam type mobile phone according to one preferred embodiment of the invention. In FIG. 1, a clam type mobile phone 100 including a base 110, a motherboard 120, a hinge seat 130, a display device 140 and a vibrator 150 is provided. The motherboard 120 is configured in the base 110. The hinge seat 130 is mounted on one side 112 of the base 110. The display device 140 is mounted on the hinge seat 130. The hinge seat 130 enables the display device 140 to rotate relative to the base 110. The vibrator 150 is configured in the hinge seat 130 and is electrically connected to the motherboard 120 for providing the clam type mobile phone 100 with a vibration function.

The clam type mobile phone 100 according to this preferred embodiment of the invention further includes at least one spring hinge 160 configured in the hinge seat 130. The spring hinge 160 enables the display device 140 to rotate relative to the base 110 partially by a spring force.

The vibrator 150 may include a motor 152 and an eccentric pendulum 154. The eccentric pendulum 154 is mounted on the motor 152 for providing the clam type mobile phone 100 with the vibration function. In this embodiment of the invention, the eccentric pendulum 154 is made of metal. However, the eccentric pendulum 154 may also be made of polymer, plastic, rubber, wood, carbon, carbon fiber or other appropriate material.

Furthermore, the clam type mobile phone 100 may further include a flexible printed circuit 170 wound around the hinge seat 130 for electrically connecting the display device 140 and the motherboard 120. In another embodiment of the invention, the flexible printed circuit 170 may be passed through the hinge seat 130 or be assembled in other ways.

In conclusion, the preferred embodiments of the invention have the advantages of:

(1) The inner space of the hinge seat is effectively utilized because the vibrator is configured in the hinge seat.

(2) The clam type mobile phone maintains small size even when a large amount of functional modules as vibrators, are configured in the clam type mobile phone.

(3) The efficiency of the vibration function is raised because the hinge seat implements a resonant effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A clam type mobile phone comprising:
a base;
a motherboard configured in the base;
a hinge seat mounted on the base;
a display device mounted on the hinge seat, whereby the hinge seat enables the display device to rotate relative to the base; and
a vibrator configured in the hinge seat and electrically connected to the motherboard.

2. The clam type mobile phone of claim 1, further comprising at least one spring hinge configured in the hinge seat.

3. The clam type mobile phone of claim 1, wherein the vibrator comprises:
a motor; and
an eccentric pendulum mounted on the motor for providing a vibration function.

4. The clam type mobile phone of claim 3, wherein the eccentric pendulum is made of metal.

5. The clam type mobile phone of claim 1, further comprising a flexible printed circuit wound around the hinge seat for electrically connecting the display device and the motherboard.

6. The clam type mobile phone of claim 1, further comprising a flexible printed circuit passed through the hinge seat for electrically connecting the display device and the motherboard.

7. A hinge assembly, configured in a clam type mobile phone, comprising:
a hinge seat, connected a base and a display device of the clam type mobile phone, whereby the hinge seat enables the display device to rotate relative to the base; and
a vibrator configured in the hinge seat and electrically connected to a motherboard of the clam type mobile phone for providing a vibration function.

8. The hinge assembly of claim 7, further comprising at least one spring hinge configured in the hinge seat.

9. The hinge assembly of claim 7, wherein the vibrator comprises:
a motor; and
an eccentric pendulum mounted on the motor for providing the vibration function.

10. The hinge assembly of claim 9, wherein the eccentric pendulum is made of metal.

11. The hinge assembly of claim 7, further comprising a flexible printed circuit wound around the hinge seat for electrically connecting the display device and the motherboard.

12. The hinge assembly of claim 7, further comprising a flexible printed circuit passed through the hinge seat for electrically connecting the display device and the motherboard.

13. A vibrator, configured in a hinge seat and electrically connected to a motherboard of a clam type mobile phone, comprising:
a motor configured in the hinge seat and electrically connected to the motherboard, wherein the hinge seat connects a base and a display device of the clam type mobile phone, the hinge seat enables the display device to rotate relative to the base; and
an eccentric pendulum mounted on the motor and positioned in the hinge seat for providing a vibration function.

14. The vibrator of claim 13, wherein the eccentric pendulum is made of metal.

15. The vibrator of claim 13, wherein the hinge seat further comprises at least one spring hinge configured in the hinge seat.

16. The vibrator of claim 13, wherein the hinge seat further comprises a flexible printed circuit wound around the hinge seat for electrically connecting the display device and the motherboard.

17. The vibrator of claim 13, wherein the hinge seat further comprises a flexible printed circuit passed through the hinge seat for electrically connecting the display device and the motherboard.
